(19) United States
(12) Patent Application Publication
(10) Pub. No.: US 2026/0257829 A1
(43) Pub. Date: Sep. 3, 2026

(54) LABEL WRAPPING MACHINE

(71) Applicant: BROTHER KOGYO KABUSHIKI KAISHA, Nagoya (JP)

(72) Inventors: Yoshimi IWAMOTO, Nagoya (JP); Masashi TANIZAKI, Kuwana (JP); Tomohiro WADA, Nagoya (JP); Shota IIJIMA, Nagoya (JP); Yuya NAKAMURA, Nagoya (JP); Ryuichi KANDA, Nagoya (JP)

(21) Appl. No.: 19/437,234

(22) Filed: Dec. 30, 2025

(30) Foreign Application Priority Data
Feb. 28, 2025 (JP) 2025-032465

(51) Int. Cl. B65C 9/26; B65C 3/02; B65C 9/00; B65C 9/18; B65C 9/46

(52) U.S. Cl. CPC B65C 9/26; B65C 3/02; B65C 9/0006; B65C 9/1807; B65C 9/1892; B65C 9/46; B65C 2009/0009; B65C 2009/0087

(57) ABSTRACT

A label wrapping machine includes a conveying guide for conveying a label with an adhesive surface and a release paper, and a peeling guide intersecting the conveying direction. A peeling portion peels the label from the release paper at the intersection. A support portion downstream of the peeling portion supports the peeled label from the non-adhesive side. A wrapping portion includes an insertion opening and a rotation member configured to rotate, while supporting, a rod-shaped member, around which the label is wrapped. A first guide portion, located upstream of the insertion opening in the insertion direction, guides the rod-shaped member to the opening. The first guide portion includes an upstream portion and a downstream portion, which respectively include at least part of the peeling portion and the support portion.

### REFERENCE TO RELATED APPLICATIONS

This application claims priority from Japanese Patent Application No. 2025-032465, filed on February 28, 2025. The entire content of the priority application is incorporated herein by reference.

### BACKGROUND ART

The present disclosure relates to a label wrapping machine.

A label affixing device includes a print portion, a peeling portion, a conveying portion, a support portion, and an affixing portion. The print portion performs printing on a label. The peeling portion peels the label printed by the print portion from a release material. The conveying portion is arranged downstream of the peeling portion in a conveying direction of the label, and includes a pair of conveying rollers. The conveying portion conveys the peeled label toward the support portion. The support portion supports the label conveyed by the conveying portion. An adherend moves from the support portion to the affixing portion together with the label. The affixing portion affixes the label to the adherend.

The above-described label affixing device includes the transport portion between the peeling portion and the support portion, and the peeling portion and the support portion are spaced apart by a distance of the transport portion. This increases the overall size of the device; accordingly, there remains room for improvement in reducing the size of the label affixing device.

### SUMMARY

Various embodiments of the general principles described herein provide a label wrapping machine that contributes to a reduction of its own size.

Embodiments herein provide a label wrapping machine according to a first aspect that includes a conveying guide, a peeling guide, a peeling portion, a support portion, a wrapping portion, and a first guide portion. The conveying guide is extending in a conveying direction and configured to convey, in the conveying direction, a label having an adhesive surface and a release paper adhered to the adhesive surface. The peeling guide is configured to convey the release paper in a direction intersecting with the conveying direction. The peeling portion is configured to peel off a conveyed label from the release paper at a point of intersection of the conveying direction and a peeling direction. The support portion is arranged downstream of the peeling portion in the conveying direction of the label and is configured to support, from a side opposite the adhesive surface, an end portion of the label peeled off by the peeling portion. The wrapping portion includes an insertion opening and a rotation member configured to rotate, while supporting, a rod-shaped member inserted through the insertion opening. The wrapping portion is configured to wrap the peeled label around the rod-shaped member. The first guide portion is arranged on a side opposite to the adhesive surface side of the label and upstream from the insertion opening in an insertion direction of the rod-shaped member. The first guide portion includes an upstream portion and a downstream portion. The upstream portion is configured to guide the rod-shaped member from upstream, relative to the insertion opening, to the insertion opening in the conveying direction of the label, and the downstream portion is configured to guide the rod-shaped member from downstream to the insertion opening. At least a portion of the upstream portion includes the peeling portion, and at least a portion of the downstream portion includes the support portion.

In the label wrapping machine, the label, from which the release paper is peeled by the peeling portion and supported at the support portion, is wrapped around the rod-shaped member inserted through the insertion opening. The first guide portion is configured to guide the rod-shaped member to the insertion opening. At least a portion of the upstream portion of the first guide portion includes the peeling portion. At least a portion of the downstream portion of the first guide portion includes the support portion. Therefore, the label wrapping machine does not require a conveying portion from the peeling portion to the support portion. Consequently, the label wrapping machine contributes to a reduction of its own size.

### BRIEF DESCRIPTION OF DRAWINGS

FIG. 1 is a perspective view of a label wrapping machine 1.

FIG. 2 is a right side cross-sectional view of the label wrapping machine taken along line I-I in FIG. 1.

FIG. 3 is an enlarged view of an area C1 in FIG. 2.

FIG. 4 is an enlarged view of an area C2 in FIG. 2, showing a state where conveying of a label has stopped at a stop position.

FIG. 5 is an enlarged view of the area C2 in FIG. 2, showing a state where a cable is placed inside a second guide portion.

FIG. 6 is an enlarged view of the area C2 in FIG. 2, showing a state where the cable is guided by the second guide portion.

FIG. 7 is an enlarged view of the area C2 in FIG. 2, showing a state where the cable, guided by a first guide portion, is arranged at an affixing position.

FIG. 8 is an enlarged view of the area C2 in FIG. 2, showing a state where the cable is guided by the first guide portion.

FIG. 9 is an enlarged view of the area C2 in FIG. 2 and is a continuation of FIG. 8.

FIG. 10 is an enlarged view of the area C2 in FIG. 2, showing the cable being guided to a wrapping portion.

### DESCRIPTION

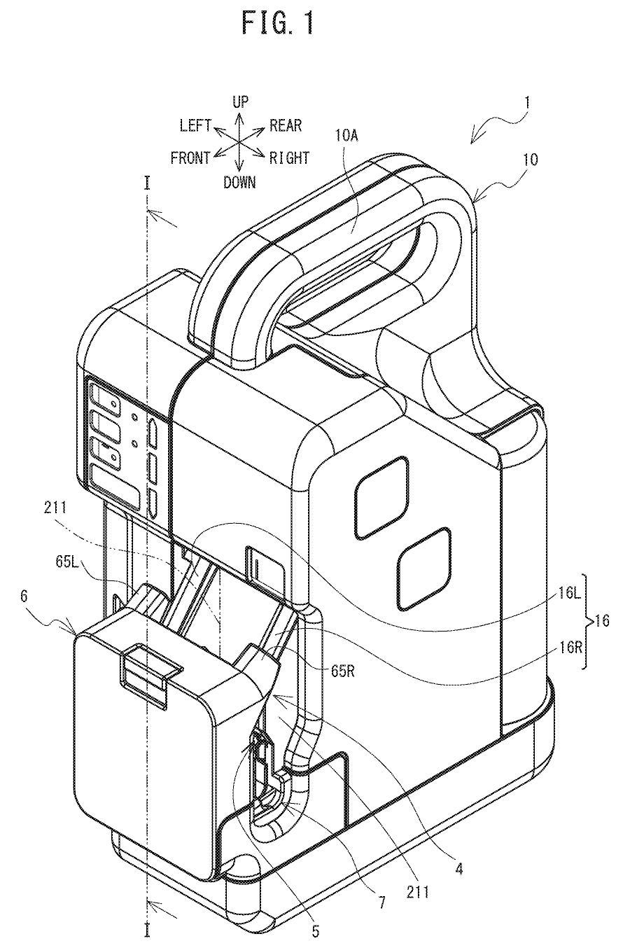

An embodiment of a label wrapping machine 1 embodying the present disclosure will be described with reference to the drawings. The referenced drawings are used to illustrate the technological features that can be adopted by the present disclosure, and illustrated configurations of devices and the like are not intended to limit the present disclosure, and are simply explanatory examples. Hereinafter, a lower left direction, an upper right direction, an upper left direction, a lower right direction, an upward direction, and a downward direction in FIG. 1 respectively correspond to a front direction, a rear direction, a left direction, a right direction, an upper direction, and a lower direction of the label wrapping machine 1.

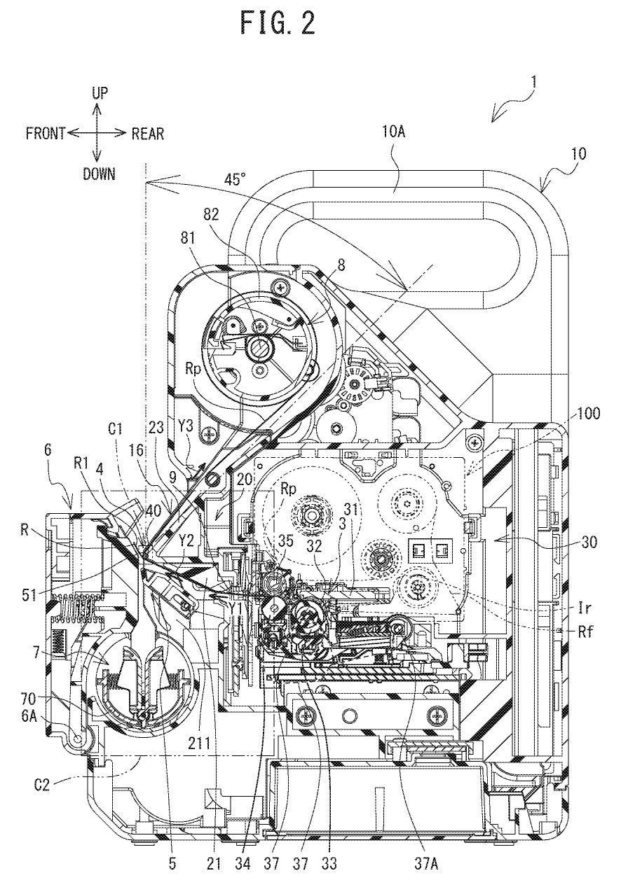

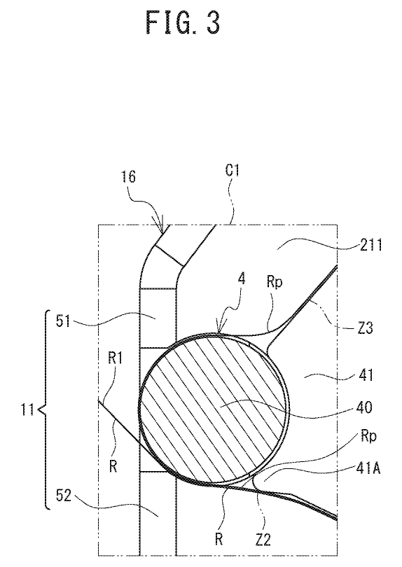

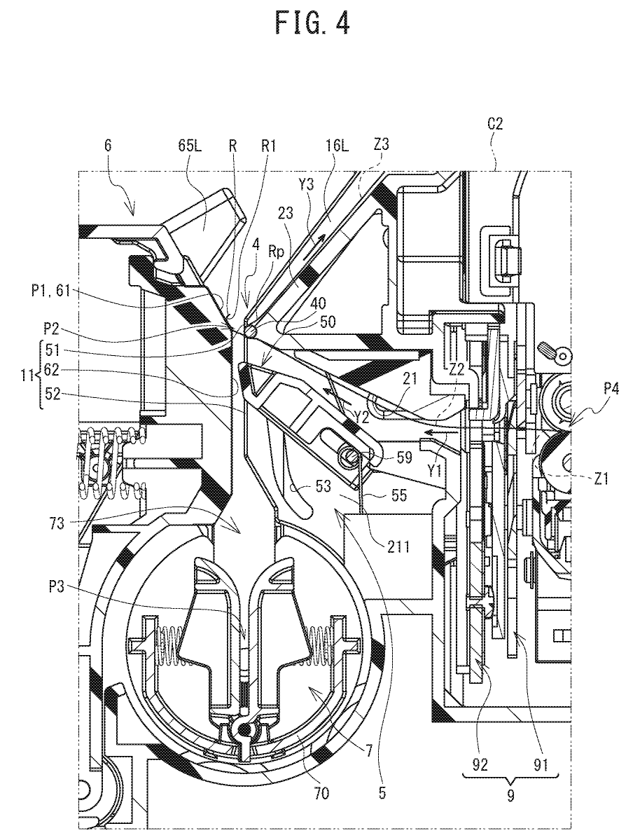

The label wrapping machine 1 will be described with reference to FIGS. 1 to 4. The label wrapping machine 1 generates a label R having an adhesive surface R1 by printing on a tape of a tape cassette 100, and wraps and affixes the generated label R around a cable 19.

The label wrapping machine 1 includes a box-shaped housing 10. The housing 10 includes a handle 10A used for carrying the label wrapping machine 1.

The housing 10 includes a tape compartment 30, a print portion 3, a cutting portion 9, a guide mechanism 20, a winding portion 8, a support portion 6, and a wrapping portion 7.

The tape compartment 30 is arranged approximately at the center in a front-rear direction and an up-down direction of the housing 10. The tape compartment 30 has a box shape open on the right side. The tape compartment 30 is capable of accommodating the tape cassette 100. The tape cassette 100 is, for example, a laminate type tape cassette, a thermal type tape cassette, or a receptacle type tape cassette, or the like.

In the following description, the tape cassette 100 will be described as the laminate type tape cassette. Inside the tape cassette 100 is housed a film tape Rf, an ink ribbon Ir, and a double-sided adhesive tape with a release paper Rp attached to one side. The film tape Rf, the ink ribbon Ir, and the double-sided adhesive tape with the release paper Rp attached are wound inside the tape cassette 100.

The print portion 3 is arranged in a lower portion of the tape compartment 30. Moreover, the print portion 3 is arranged upstream in a conveying direction Y1 of a peeling portion 4 described later.

The print portion 3 includes a head holder 31, a thermal head 32, a platen holder 37, a platen roller 33, a conveying roller 34, and a drive roller 35 and the like.

The head holder 31 has a plate shape. The head holder 31 extends in the front-rear direction and a left-right direction. The thermal head 32 is supported by the head holder 31. The thermal head 32 includes a plurality of heating elements. The plurality of heating elements are arranged in a row in the left-right direction.

In a state in which the tape cassette 100 is installed in the tape compartment 30, the thermal head 32 heats the ink ribbon Ir by the plurality of heating elements and transfers ink onto the film tape Rf.

The platen holder 37 is arranged below the head holder 31. The platen holder 37 is supported so as to be rotatable about the axis of a support shaft 37A.

The platen roller 33 and the conveying roller 34 are rotatably supported at the tip end side of the platen holder 37. The conveying roller 34 is arranged to the left of the platen roller 33. When the platen holder 37 swings to a print position, the platen roller 33 contacts the thermal head 32.

The drive roller 35 is arranged above the platen roller 33 positioned at the print position. In other words, the drive roller 35 faces the conveying roller 34 from above. The drive roller 35 is driven by the driving force of a motor, for example. When the platen holder 37 swings to the print position, the drive roller 35 can contact the conveying roller 34. A position between the platen holder 37 and the conveying roller 34 is also referred to as an adhering position P4.

The cutting portion 9 is arranged downstream of the conveying roller 34 of the print portion 3 in the conveying direction Y1 of the tape. The cutting portion 9 includes a full cutter 91 and a half cutter 92. Both the full cutter 91 and the half cutter 92 are cutting blades.

The full cutter 91 cuts the label R and the release paper Rp between the peeling portion 4, described later, and the print portion 3. The half cutter 92 cuts only the label R without cutting the release paper Rp, between the peeling portion 4 and the print portion 3.

The guide mechanism 20 guides the label R, which has been half-cut by the cutting portion 9, and the release paper Rp to the peeling portion 4. The guide mechanism 20 guides the release paper Rp to the winding portion 8, described later. The guide mechanism 20 guides the cable 19 to the wrapping portion 7 in the insertion direction. The insertion direction refers to the direction in which a user inserts the cable 19 into the wrapping portion 7. The insertion direction is downward.

The guide mechanism 20 includes left and right side walls 211 and 211, a conveying guide 21, a movable member 50, a guide portion 5, the peeling portion 4, a peeling guide 23, and a second guide portion 16.

The left and right side walls 211 and 211 are arranged at the front lower end portion of the housing 10. The left and right side walls 211 and 211 extend upward from a bottom portion of the housing 10. Upper end portions of the left and right side walls 211 and 211 incline upward from the front toward the rear.

The conveying guide 21 is arranged between the left and right side walls 211 and 211. The conveying guide 21 is arranged between the cutting portion 9 and the peeling portion 4. The conveying guide 21 is inclined upward from upstream to downstream in a conveying direction Y2. The conveying guide 21 has a surface facing the front lower direction.

The movable member 50 is arranged between the left and right side walls 211 and 211. The movable member 50 is arranged below the conveying guide 21. The movable member 50 extends in the left-right direction. The movable member 50 is rotatable around a shaft 59. A front end portion of the movable member 50 rotates in a counterclockwise direction along a cam 53. The movable member 50 is urged in a clockwise direction when viewed from the right by the urging force of a spring 55.

In the state urged by the spring 55, an upper surface of the movable member 50 faces the conveying guide 21. That is, the upper surface of the movable member 50 faces upward and rearward.

The guide portion 5 is arranged at front end portions of the left and right side walls 211 and 211. The guide portion 5 is arranged upstream in the insertion direction of the cable 19 with respect to an insertion opening 73 of the wrapping portion 7.

The guide portion 5 includes guide surfaces 51 and 52. Hereinafter, the guide surfaces 51 and 52 arranged on the right side wall 211 will be described. The guide surfaces 51 and 52 of the left side wall 211 have the same structure, so a description thereof will be omitted.

The guide surfaces 51 and 52 extend in the up-down direction, that is, in the insertion direction of the cable 19. The guide surfaces 51 and 52 face forward. The guide surfaces 51 and 52 are arranged spaced apart in the up-down direction.

The guide surface 51 is arranged on the adhesive surface R1 side of the label R near an affixing position P2 in the insertion direction of the cable 19. The guide surface 51 is arranged above the label R. The affixing position P2 is a position where the cable 19 is affixed to the label R supported by a support surface 61. The affixing position P2 corresponds to the peeling portion 4.

The guide surface 52 is arranged on the opposite side to the adhesive surface R1 of the label R in the insertion direction of the cable 19. The guide surface 52 is arranged below the label R.

The guide surfaces 51 and 52 can contact the cable 19 from the upstream in the conveying direction Y2 of the label R.

The peeling portion 4 is arranged at the downstream-most position in the conveying direction Y2 of the guide mechanism 20. The peeling portion 4 is arranged between a lower end of the guide surface 51 and an upper end of the guide surface 52. At least a portion of the guide mechanism 20 includes the peeling portion 4.

The peeling portion 4 includes a support member 41 and a roller 40.

The support member 41 is arranged between the left and right side walls 211 and 211. The support member 41 extends in the left-right direction. The support member 41 extends in the left-right direction, with a front end portion being recessed to the rear. A lower end portion of the support member 41 extends forward and downward. This portion is also referred to as a third guide portion 41A.

The third guide portion 41A is arranged between the peeling portion 4 and the movable member 50. The third guide portion 41A protrudes along a right lower portion of the roller 40 in the conveying direction Y2. The third guide portion 41A guides the label R and the release paper Rp in a direction away from the peeling portion 4.

The roller 40 extends in the left-right direction. An outer peripheral surface of the roller 40 is uneven. Because the outer peripheral surface is uneven and non-uniform, the outer peripheral surface of the roller 40 has non-adhesive properties. A rear end of the roller 40 is rotatably supported by the support member 41.

Furthermore, a front upper end of the roller 40 is positioned by abutting against a lower right end of the guide surface 51. A front lower end of the roller 40 is positioned by abutting against the upper end of the guide surface 52. In other words, at least a portion of the guide surfaces 51 and 52 constitutes the peeling portion 4.

The roller 40 is rotatably supported by the support member 41 and the guide surfaces 51 and 52. A front end of the roller 40 protrudes forward beyond the guide surfaces 51 and 52. That is, the front end of the roller 40 protrudes to the farthest downstream in the guide mechanism 20.

The peeling guide 23 is arranged between the left and right side walls 211 and 211. The peeling guide 23 extends upward and toward the rear from the peeling portion 4. The peeling guide 23 has a surface facing forward and upward. The peeling guide 23 supports a lower surface of the release paper Rp.

The second guide portion 16 includes a first guide 16L and a second guide 16R. The first guide 16L and the second guide 16R are respectively arranged at the upper end portions of the left and right side walls 211 and 211. The first guide 16L and the second guide 16R are arranged at both ends of the peeling guide 23. The first guide 16L and the second guide 16R are arranged along a winding path Z3 of the release paper Rp between the first guide 16L and the second guide 16R, and the winding portion 8.

The second guide portion 16 is inclined at an angle smaller than 45 degrees with respect to the insertion direction. The second guide portion 16 guides the movement of the cable 19 in the insertion direction. Specifically, the second guide portion 16 guides movement toward the guide surface 51.

The first guide 16L and the second guide 16R extend along the peeling guide 23. In other words, the first guide 16L and the second guide 16R are arranged along the winding path Z3 between the peeling portion 4 and the winding portion 8.

The first guide 16L extends upward from a left end portion of the peeling guide 23. The first guide 16L protrudes upward to a height equal to or higher than the thickness of the release paper Rp from a position away from, to the left of, the release paper Rp located in the winding path Z3. A front end of the first guide 16L connects to an upper end of the right guide surface 51.

The second guide 16R extends upward from a right end portion of the peeling guide 23. The second guide 16R protrudes upward to a height equal to or higher than the thickness of the release paper Rp from a position away from, to the right of, the release paper Rp located in the winding path Z3. A front end of the second guide 16R connects to an upper end of the left guide surface 51.

The winding portion 8 is arranged diagonally above and to the rear of the peeling portion 4. The winding portion 8 is arranged above a front upper corner portion of the tape compartment 30. The winding portion 8 includes a winding roller 82. The winding roller 82 winds up the release paper Rp, from which the label R has been peeled off by the peeling portion 4, into a roll toward a winding direction Y3. The winding roller 82 rotates around a winding shaft 81.

The support portion 6 is arranged downstream of the peeling portion 4 in the conveying direction Y1 of the label R. The support portion 6 has a box shape and extends in the up-down direction. The support portion 6 is rotatable around a shaft body 6A.

The support portion 6 includes the support surface 61, protrusions 65L and 65R, and a pressing surface 62.

The support surface 61 is arranged at an upper end and a rear end of the support portion 6. The support surface 61 faces diagonally upward and to the rear. The support surface 61 supports the label R at a stop position P1 from below. The position of the label R in this state is also referred to as the stop position P1. The stop position P1 is a position where the label R is peeled off of the release paper Rp and conveying of the label R in the conveying direction Y2 is stopped.

The pair of protrusions 65L and 65R are arranged at an upper end portion of the support portion 6. The protrusion 65L is arranged at a left end portion of the support portion 6. The protrusion 65R is arranged at a right end portion of the support portion 6. The protrusions 65L and 65R protrude toward the downstream in the winding direction Y3. Lower surfaces of the protrusions 65L and 65R face front end portions of the first guide 16L and the second guide 16R, respectively.

The pressing surface 62 is arranged at a rear end portion of the support portion 6. The pressing surface 62 extends in the up-down direction and left-right directions. The pressing surface 62 faces the guide surface 51. The pressing surface 62 contacts the cable 19 from the downstream in the conveying direction Y1 of the label R, and guides the cable 19 to the wrapping portion 7 of the label R.

The upper ends of the guide surface 51 and the pressing surface 62 guide the movement of the cable 19 to the affixing position P2 in the insertion direction of the cable 19.

Hereinafter, the guide surfaces 51 and 52 and the pressing surface 62 are also collectively referred to as a “first guide portion 11”. In other words, the first guide portion 11 guides the movement of the cable 19 toward the affixing position P2 in the insertion direction of the cable 19.

The wrapping portion 7 is arranged at the bottom portion of the housing 10. The wrapping portion 7 is positioned below the peeling portion 4 and the support surface 61. The wrapping portion 7 includes the insertion opening 73 and a rotation member 70.

The insertion opening 73 is arranged above the wrapping portion 7. The cable 19, to which a portion of the label R, is attached is inserted into the insertion opening 73. The rotation member 70 has a substantially cylindrical shape. The rotation member 70 rotates by the driving force of a motor. The label R is wound onto the cable 19 by the rotation of the rotation member 70.

A printing operation and a winding operation will now be described. The user installs the tape cassette 100 into the tape compartment 30. The conveying roller 34 presses the double-sided adhesive tape, to which the film tape Rf and the release paper Rp are adhered, against the drive roller 35 at the adhering position P4. The platen roller 33 presses the film tape Rf and the ink ribbon Ir against the thermal head 32.

The user edits print information on an external terminal, for example, and transmits the edited print information to the label wrapping machine 1. The label wrapping machine 1 executes printing based on the print information.

Upon execution of the printing, the drive roller 35 is rotationally driven, transporting the film tape Rf and the ink ribbon Ir inside the tape cassette 100. More specifically, the platen roller 33 rotates together with the drive roller 35, conveying the film tape Rf and the ink ribbon Ir toward the thermal head 32.

The thermal head 32 heats the ink ribbon Ir. The ink from the ink ribbon Ir is transferred onto the print surface of the film tape Rf. Thereafter, the film tape Rf is conveyed to the adhering position P4. Note that the ink ribbon Ir is wound up inside the tape cassette 100.

Moreover, the conveying roller 34 rotates together with the rotation of the drive roller 35, conveying the printed film tape Rf and the double-sided adhesive tape with release paper Rp attached, to the adhering position P4. At the adhering position P4, the double-sided adhesive tape with the release paper Rp attached is adhered to the film tape Rf. Thereafter, the film tape Rf and the release paper Rp are discharged outside the tape cassette 100.

The cutting portion 9 cuts only the film tape Rf using the half cutter 92. The label R is conveyed together with the release paper Rp in the conveying direction Y2. The label R and the release paper Rp proceed toward the peeling portion 4.

Between the conveying guide 21 and the movable member 50, the release paper Rp, adhered to the adhesive surface R1 of the label R, is conveyed in the conveying direction Y2 together with the label R.

The peeling portion 4 peels the conveyed label R from the release paper Rp at the intersection of the conveying guide 21 and the peeling guide 23, that is, at the position of the roller 40. At the peeling portion 4, the release paper Rp is bent at an obtuse angle with the peeling portion 4 on the inside. The end portion of the label R is peeled away from the release paper Rp.

The release paper Rp is conveyed toward the winding portion 8. The peeling guide 23 conveys the release paper Rp in a direction intersecting with the conveying guide 21. The second guide portion 16 guides the cable 19 toward the first guide portion 11. Subsequently, the release paper Rp is wound by the winding portion 8. The winding portion 8 applies tension to the release paper Rp by the winding roller 82 winding the release paper Rp.

The support surface 61 supports, from the side opposite to the adhesive surface R1, the downstream end portion in the conveying direction Y2 of the label R that was peeled off by the peeling portion 4. The end portion of the label R that peeled away from the release paper Rp rides up on the support surface 61.

The protrusions 65L and 65R cover, from the upstream in the insertion direction of the cable 19, at least a portion of the downstream end portion of the label R in the conveying direction Y2 that is supported by the support surface 61. Consequently, the protrusions 65L and 65R can prevent the cable 19 from contacting at least a portion of the downstream end portion of the label R.

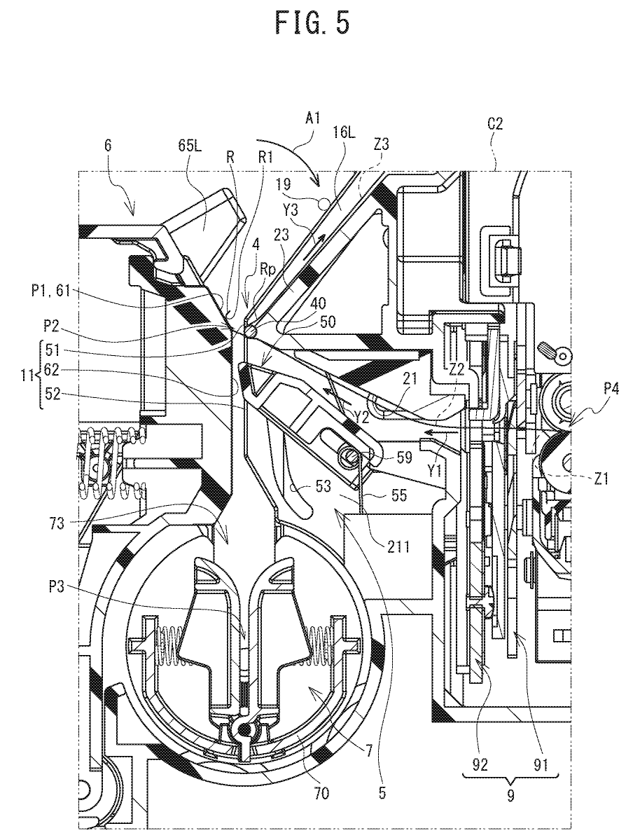

As shown in FIG. 5, the user grips the cable 19 extending in the left-right direction with both hands and places the cable 19 onto the second guide portion 16 from the direction of arrow A1, for example. The cable 19 contacts the first guide 16L and the second guide 16R of the second guide portion 16.

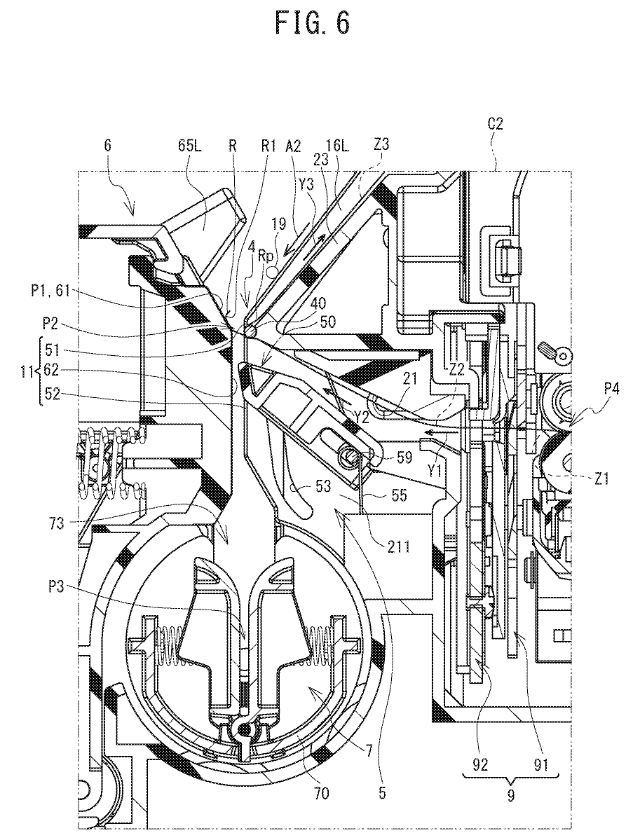

As shown in FIG. 6, the user moves the cable 19 toward the label R supported by the support surface 61. The user moves the cable 19 in the direction of arrow A2 while keeping the cable 19 in contact with the first guide 16L and the second guide 16R.

Because the incline angle of the second guide portion 16 is less than 45 degrees, the user can easily move the cable 19. Contact with the release paper Rp is prevented by the first guide 16L and the second guide 16R. Therefore, the effect from the cable 19 contacting the release paper Rp on the tension applied to the release paper Rp is minimal for the user.

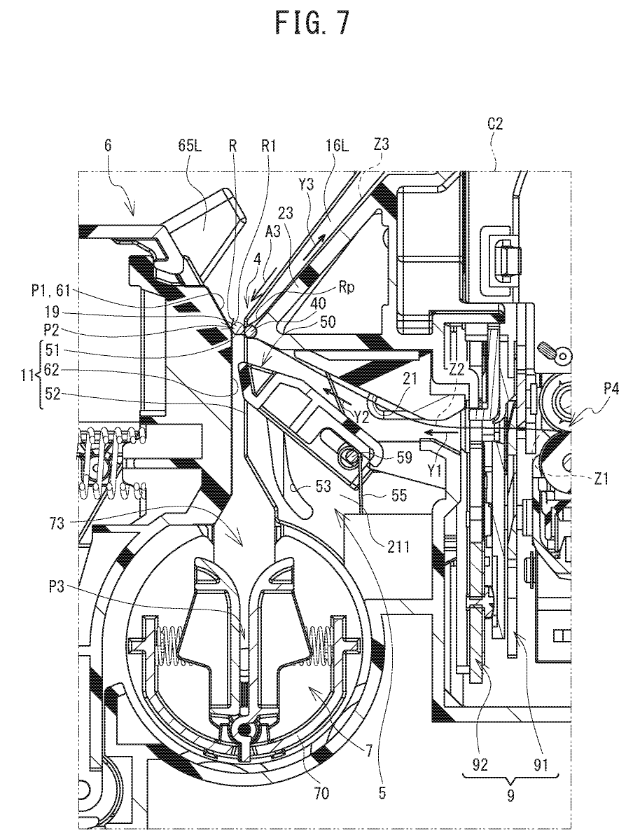

As shown in FIG. 7, the cable 19 moves in the direction of arrow A3 toward the affixing position P2. In this case, the movement of the cable 19 in the insertion direction is guided by the first guide portion 11. More specifically, the left and right guide surfaces 51 and 51 and an upper end portion of the pressing surface 62 guide the movement of the cable 19 toward the affixing position P2.

The guide surface 51 guides the cable 19 from the upstream in the conveying direction Y2 of the label R toward the insertion opening 73. In other words, the guide surface 51 contacts the cable 19 from the rear and guides the movement of the cable 19 downward. The upper end portion of the pressing surface 62 guides the cable 19 from the downstream in the conveying direction Y2 to the insertion opening 73. In other words, the upper end portion of the pressing surface 62 contacts the cable 19 from the front and guides the movement of the cable 19 downward. The upper end portion of the pressing surface 62 presses the cable 19 against the guide surface 51.

At the affixing position P2, the cable 19 is adhered to a portion of the label R. When viewed from upstream in the insertion direction, the user can visually confirm at least a portion of the peeling portion 4 through a space between the protrusion 65L and the protrusion 65R. Accordingly, the user can easily perform the insertion operation of the cable 19.

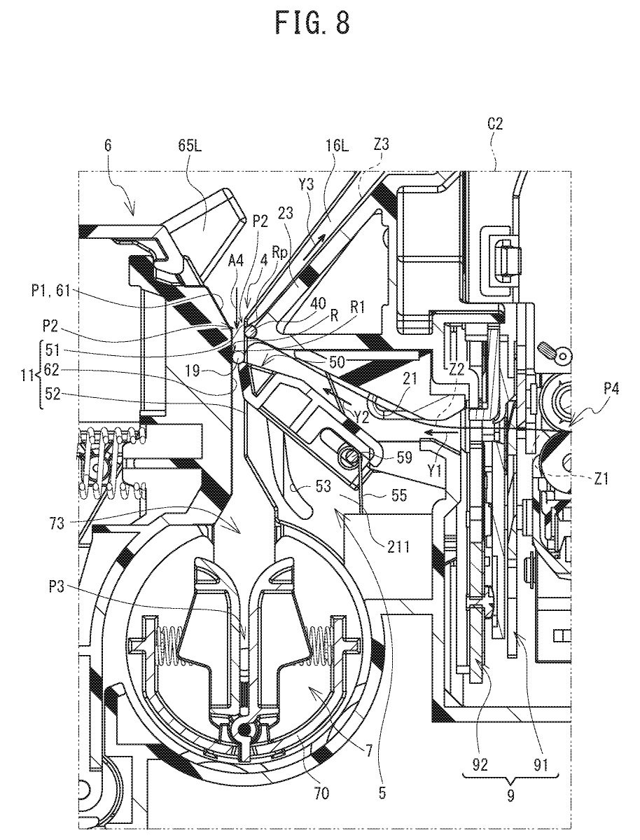

As shown in FIG. 8, the user further moves the cable 19 in the direction of arrow A4, that is, downward, from the affixing position P2. The movement of the cable 19 is guided in the insertion direction by the first guide portion 11. More specifically, the upper end portions of the guide surfaces 52 and 52 and the upper end portion of the pressing surface 62 guide the movement of the cable 19 toward the movable member 50. The label R moves downward together with the cable 19. The cable 19 and the label R come into contact with the front end portion of the movable member 50.

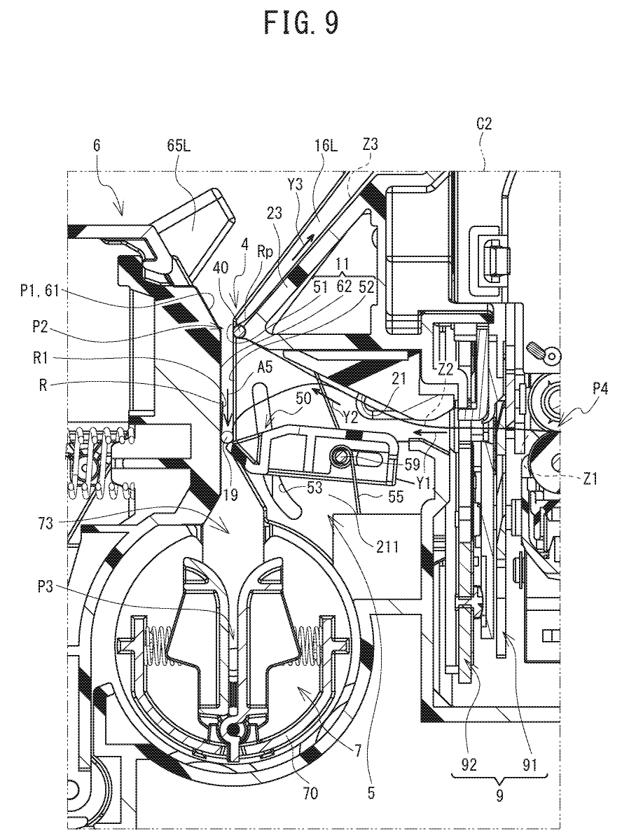

As shown in FIG. 9, the user further moves the cable 19 in the direction of arrow A5, that is, downward. The first guide portion 11 guides the cable 19, together with the label R, downward toward the wrapping portion 7. More specifically, the left and right guide surfaces 52 and 52 and the pressing surface 62 contact the cable 19 from the upstream in the conveying direction Y2 of the label R, and guide the cable 19 into the insertion opening 73.

The movable member 50 rotates counterclockwise about the shaft 59 against the urging force of the spring 55. Note that the label R adhered to the cable 19 is peeled away from the release paper Rp as the cable 19 moves downward.

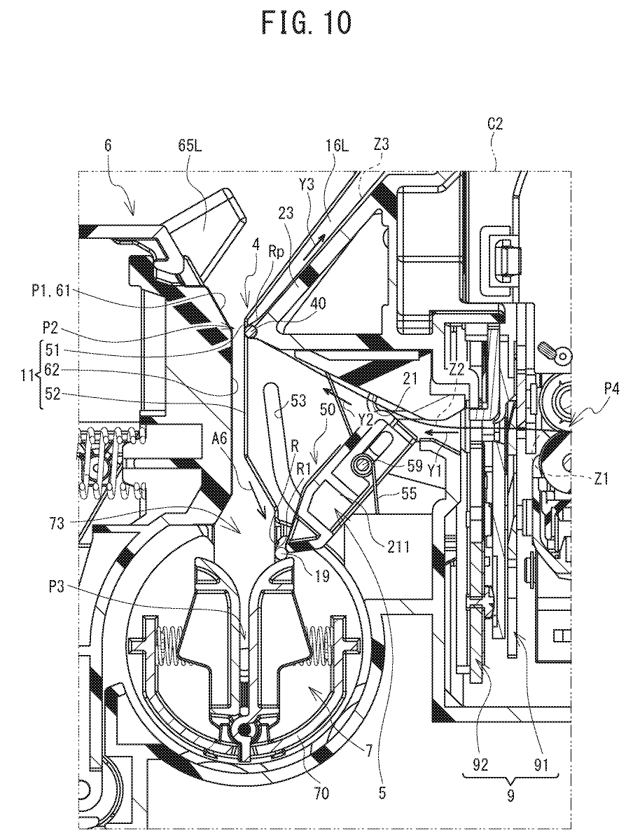

As shown in FIG. 10, the user moves the cable 19 to the wrapping portion 7 through the insertion opening 73.

Subsequently, the user places the cable 19 inserted from the insertion opening 73 at a supported position P3. The rotation member 70 supports and rotates the cable 19 inserted from the insertion opening 73. Consequently, the rotation member 70 wraps the label R, which has been peeled by the peeling portion 4, around the cable 19. Therefore, the label R is affixed to the cable 19 by adhesive.

The user takes out the cable 19 around which the label R has been wrapped. The user visually confirms whether the label R has been properly wrapped around the cable 19.

As described above, the first guide portion 11 is arranged upstream, in the insertion direction of the cable 19, of the insertion opening 73. The guide surface 51 is arranged on the adhesive surface R1 side of the label R. The first guide portion 11 guides the cable 19 into the insertion opening 73. The first guide portion 11 includes the guide surface 51 that guides the label R from the upstream in the conveying direction Y2 to the insertion opening 73, and the support portion 6 that guides the label R from the downstream to the insertion opening 73. At least a portion of the guide mechanism 20 includes the peeling portion 4. At least a portion of the support portion 6 includes the support surface 61.

In the label wrapping machine 1, the label R, from which the release paper Rp has been peeled off by the peeling portion 4 and which is supported by the support portion 6, is wound around the cable 19 inserted through the insertion opening 73. The first guide portion 11 guides the cable 19 to the insertion opening 73. At least a portion of the guide mechanism 20 of the first guide portion 11 includes the peeling portion 4. At least a portion of the support portion 6 of the first guide portion 11 includes the support surface 61. Therefore, the label wrapping machine 1 does not need to include a conveying portion from the peeling portion 4 to the support portion 6. Accordingly, the label wrapping machine 1 contributes to reducing the size of the label wrapping machine 1.

The second guide portion 16 is arranged along the winding path Z3 of the release paper Rp between the peeling portion 4 and the winding portion 8 that winds the release paper Rp. The second guide portion 16 guides the cable 19 toward the guide surface 51 of the first guide portion 11. Because the second guide portion 16 is arranged along the winding path Z3, the label wrapping machine 1 can be made smaller than it can when the second guide portion 16 is arranged independently. Furthermore, the downstream end portion in the conveying direction Y2 of the label R supported by the support portion 6 is prone to curling. The user guides the cable 19 with the second guide portion 16 from the side opposite to the end portion where the curling occurs in the conveying path Z2. As a result, the cable 19 is less likely to come into contact with the curl of the label R. Therefore, the label wrapping machine 1 contributes to suppressing jamming of the label R and inhibiting the orientation of the label R from changing.

The winding portion 8 winds the release paper Rp, from which the label R has been peeled off by the peeling portion 4, in the winding direction Y3. The support portion 6 includes the protrusions 65L and 65R. The protrusions 65L and 65R protrude toward the upstream in the winding direction Y3. The protrusions 65L and 65R cover, from the upstream in the insertion direction, at least a portion of the downstream end portion, in the conveying direction Y2, of the label R supported by the support portion 6. The downstream end portion in the conveying direction Y2 of the label R, which is supported by the support portion 6, is prone to curling. The protrusions 65L and 65R contribute to suppressing contact of the cable 19 with the label R from the downstream end portion.

At least a portion of the peeling portion 4 is visible when viewed from the upstream in the insertion direction. The label wrapping machine 1 contributes to enabling the user to visually observe the peeling portion 4 unobstructed by the protrusions 65L and 65R. For this reason, the label wrapping machine 1 contributes to making it easier for the user to insert the cable 19 using a portion of the peeling portion 4 as a mark.

The second guide portion 16 includes the first guide 16L and the second guide 16R. The first guide 16L and the second guide 16R are arranged along the winding path Z3 between the peeling portion 4 and the winding portion 8. The first guide 16L protrudes upward to a height equal to or greater than the thickness of the release paper Rp from a position away from, to the left of, the release paper Rp located in the winding path Z3. The second guide 16R protrudes upward to a height equal to or higher than the thickness of the release paper Rp from a position away from, to the right of, the release paper Rp located in the winding path Z3. The user moves the cable 19 in the direction opposite to the winding direction Y3 of the release paper Rp along the first guide 16L and the second guide 16R. The first guide 16L and the second guide 16R contribute to reducing the possibility of the user mistakenly causing the cable 19 to contact the release paper Rp. Accordingly, the label wrapping machine 1 contributes to inhibiting interference of the winding of the release paper Rp by the winding roller 82.

The wrapping portion 7 is arranged below the peeling portion 4 and the support portion 6. The first guide portion 11 guides the cable 19 downward toward the wrapping portion 7 together with the label R. The second guide portion 16 is inclined at an angle less than 45 degrees with respect to the insertion direction of the cable 19. Because the path for inserting the cable 19 into the wrapping portion 7 does not go against gravity, the label wrapping machine 1 contributes to easy insertion of the cable 19 by the user. Furthermore, because the inclination of the second guide portion 16 is less than 45 degrees with respect to the insertion direction, the label wrapping machine 1 contributes to easy guiding of the cable 19 along the second guide portion 16 by the user.

At least a portion of the peeling portion 4 protrudes furthest downstream among the members of the guide mechanism 20 of the first guide portion 11. The label wrapping machine 1 contributes to the user affixing the label R to the cable 19 while contacting the peeling portion 4 without interference from other members. Accordingly, the label wrapping machine 1 contributes to making it easier for the user to keep the cable 19 straight with respect to the label R.

The peeling portion 4 includes the rotatably supported roller 40. Because the roller 40 rotates as the release paper Rp is conveyed, the label wrapping machine 1 contributes to reducing the adhesion of the glue of the release paper Rp to the peeling portion 4.

The outer peripheral surface of the roller 40 may be uneven. The label wrapping machine 1 contributes to further reducing the adhesion of the glue of the release paper Rp by means of the irregularities on the roller 40.

The third guide portion 41A is arranged between the peeling portion 4 and the movable member 50 that conveys the label R and the release paper Rp. The third guide portion 41A guides the label R in the direction away from the peeling portion 4. Prior to using the label wrapping machine 1, the user arranges the label R and the release paper Rp along the conveying paths Z1 and Z2. The third guide portion 41A contributes to suppressing the collision of the downstream end portion in the conveying direction Y2 of the label R and release paper Rp with the peeling portion 4 when the user moves the label R and the release paper Rp to the peeling portion 4.

The winding roller 82 winds the release paper Rp. The winding roller 82 applies tension to the release paper Rp by winding the release paper Rp. The label wrapping machine 1 contributes to stable peeling of the label R by applying tension to the release paper Rp.

The print portion 3 is arranged upstream in the conveying direction Y2 of the peeling portion 4. The print portion 3 performs printing on the label R. The label wrapping machine 1 contributes to printing on the label R before peeling.

The half cutter 92 cuts only the label R between the peeling portion 4 and the print portion 3. Because the label R can be half-cut, the label wrapping machine 1 contributes to accommodating the label R of an indefinite length.

The full cutter 91 cuts the label R and the release paper Rp between the peeling portion 4 and the print portion 3. Because full cutting is possible, the label wrapping machine 1 contributes to making it easier for the user to remove the label R and the release paper Rp.

In the above description, the cable 19 is an example of the “rod-shaped member” of the present disclosure. The guide surface 51 and guide mechanism 20 are examples of the “upstream portion” of the present disclosure. The support portion 6 is an example of the “downstream portion” of the present disclosure. The support surface 61 is an example of the “support portion” of the present disclosure. The support surface 61, the conveying paths Z1 and Z2, and the winding path Z3 are examples of the “peeling path” of the present disclosure.

The winding portion 8 is an example of the “tensioner” of the present disclosure. The right direction is an example of “one side in the width direction” of the present disclosure. The left direction is an example of “the other side in the width direction” of the present disclosure.

The movable member 50 is an example of the “conveying portion” of the present disclosure.

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

The above-described embodiment and modified examples may further be modified in various ways as described below. The present disclosure and the various modified examples described below can be combined as long as no contradictions arise.

The arrangements and configurations of components of the label wrapping machine 1 according to the above-described embodiment may be modified as appropriate. The conveying direction Y1 does not necessarily have to be to the left. The conveying direction Y2 does not necessarily have to be upward and toward the front. The winding direction Y3 does not necessarily have to be upward and toward the rear. For example, the insertion direction of the cable 19 was downward, but it is not limited to this and may be changed as appropriate.

In the above-described embodiment, the label R was wound around the cable 19; however, the present disclosure is not limited to this. For example, instead of the cable 19, the label R may be wound around stationery such as a pen, or tools such as a screwdriver.

In the above-described embodiment, the winding portion 8 applied tension to the release paper Rp, but the present disclosure is not limited to this. For example, instead of the winding portion 8, a separate tensioner may be provided. For example, the tensioner may be a pair of rollers which nip-feed the release paper Rp, thereby applying tension to the release paper Rp.

In the above-described embodiment, the second guide portion 16 was inclined at an angle smaller than 45 degrees; however, the present disclosure is not limited to this. For example, the second guide portion 16 may be inclined at an angle of 45 degrees or greater. The second guide portion 16 was arranged in the winding path Z3, but the second guide portion 16 may be arranged in another position. For example, the second guide portion 16 may be a separate body.

In the above-described embodiment, the support portion 6 was rotatable; however, the present disclosure is not limited to this. For example, the support portion 6 may be non-rotatable. The inclination of the support surface 61 of the support portion 6 may be changed as appropriate. The support surface 61 may be arranged separately from the support portion 6. The pressing surface 62 may be arranged separately from the support portion 6. The protrusions 65R and 65L may be omitted.

What is claimed is:

1. A label wrapping machine, comprising:
a conveying guide extending in a conveying direction and configured to convey, in the conveying direction, a label having an adhesive surface, and a release paper adhered to the adhesive surface of the label;
a peeling guide configured to convey the release paper in a direction intersecting with the conveying direction;
a peeling portion configured to peel off a conveyed label from the release paper at a point of intersection of the conveying direction and a peeling direction;
a support portion arranged downstream of the peeling portion in the conveying direction of the label, the support portion configured to support, from a side opposite the adhesive surface, an end portion, which is downstream in the conveying direction, of the label peeled off by the peeling portion;
a wrapping portion in which an insertion opening is arranged and which includes a rotation member configured to rotate, while supporting, a rod-shaped member inserted through the insertion opening, the wrapping portion configured to wrap the label peeled off by the peeling portion around the rod-shaped member; and
a first guide portion arranged on a side opposite to the adhesive surface side of the label and upstream from the insertion opening, in an insertion direction of the rod-shaped member, the first guide portion configured to guide the rod-shaped member to the insertion opening,
wherein the first guide portion includes an upstream portion and a downstream portion, the upstream portion configured to guide the rod-shaped member from upstream, relative to the insertion opening, to the insertion opening in the conveying direction of the label, and the downstream portion configured to guide the rod-shaped member from downstream to the insertion opening,
wherein at least a portion of the upstream portion includes the peeling portion, and
wherein at least a portion of the downstream portion includes the support portion.

2. The label wrapping machine according to claim 1, further comprising:
a second guide portion arranged along a peeling path of the release paper between the peeling portion and a tensioner configured to wind the release paper, the second guide portion configured to guide the rod-shaped member toward the upstream portion of the first guide portion.

3. The label wrapping machine according to claim 1, further comprising:
a winding portion configured to wind, in a winding direction, the release paper from which the label has been peeled off by the peeling portion,
wherein the support portion includes a protrusion configured to cover, from upstream in the insertion direction, at least a portion of the end portion, which is downstream in the conveying direction, of the label supported by the support portion, and protrude downstream in the winding direction.

4. The label wrapping machine according to claim 3, wherein
at least a portion of the peeling portion is visible when viewed from upstream in the insertion direction.

5. The label wrapping machine according to claim 2, wherein
the second guide portion includes:
a first guide along a winding path between the peeling portion and the tensioner, the first guide configured to protrude upward to a height equal to or higher than a thickness of the release paper from a position away from, in a width direction of the release paper, one side of the release paper in the winding path, and
a second guide along the winding path between the peeling portion and the tensioner, the second guide configured to protrude upward to a height equal to or higher than the thickness of the release paper from a position away from, in the width direction of the release paper, the other side of the release paper in the winding path.

6. The label wrapping machine according to claim 2, wherein
the wrapping portion is arranged below the peeling portion and the support portion,
the first guide portion is configured to guide the rod-shaped member downward toward the wrapping portion together with the label, and
the second guide portion is inclined at an angle smaller than 45 degrees with respect to the insertion direction of the rod-shaped member.

7. The label wrapping machine according to claim 1, wherein
at least a portion of the peeling portion protrudes furthest downstream among members of the upstream portion of the first guide portion.

8. The label wrapping machine according to claim 1, wherein
the peeling portion is a rotatably supported roller.

9. The label wrapping machine according to claim 8, wherein
an outer peripheral surface of the roller is irregular.

10. The label wrapping machine according to claim 1, further comprising:
a third guide portion arranged between the peeling portion and a conveying portion configured to convey the label and the release paper, the third guide portion configured to guide the label in a direction away from the peeling portion.

11. The label wrapping machine according to claim 1, further comprising:
a winding roller configured to wind the release paper,
wherein the winding roller applies tension to the release paper by winding the release paper.

12. The label wrapping machine according to claim 1, further comprising:
a print portion configured to print on a label upstream in the conveying direction of the peeling portion.

13. The label wrapping machine according to claim 12, further comprising:
a half cutter configured to cut only the label, between the peeling portion and the print portion.

14. The label wrapping machine according to claim 12, further comprising:
a full cutter configured to cut the label and the release paper, between the peeling portion and the print portion.
